(19) United States
(12) Patent Application Publication
(10) Pub. No.: US 2019/0129882 A1
(43) Pub. Date: May 2, 2019

(54) MULTI-CONNECTOR MODULE DESIGN FOR PERFORMANCE SCALABILITY

(71) Applicant: NVXL Technology, Inc., Fremont, CA (US)

(72) Inventors: Bharadwaj Pudipeddi, San Jose, CA (US); Anthony Gallippi, Danville, CA (US); Vijay Devadiga, San Ramon, CA (US)

(21) Appl. No.: 16/174,722

(22) Filed: Oct. 30, 2018

Related U.S. Application Data
(60) Provisional application No. 62/579,059, filed on Oct. 30, 2017.

(51) Int. Cl. G06F 13/40

(52) U.S. Cl. CPC G06F 13/4081; H01R 25/006

(57) ABSTRACT

Disclosed techniques include platform optimization for multi-platform module design for performance scalability. A compute platform pluggable module form factor and functionality is obtained, where the form factor enables single socket plugging within a plurality of sockets on a compute platform. The form factor employs electrical connections in each socket. A scaling form factor commensurate with adjacent sockets on the compute platform is established. The adjacent sockets each provide similar functionality for modules, and the adjacent sockets can be used interchangeably without loss of functionality of the compute platform. A single, integrated, rigid module is provided according to the scaling form factor that plugs into the adjacent sockets of the compute platform. The module provides expanded functionality over a single-plug form factor module. The expanded functionality is enabled through use of the electrical connections of the adjacent sockets. The module is detected as a single device by the compute platform.

### RELATED APPLICATIONS

This application claims the benefit of U.S. provisional patent application “Multi-Connector Module Design for Performance Scalability” Ser. No. 62/579,059 filed Oct. 31, 2017.

The foregoing application is hereby incorporated by reference in its entirety.

### FIELD OF ART

This application relates generally to compute platform optimization and more particularly to multi-connector module design for performance scalability.

### BACKGROUND

Processing of data, particularly vast amounts of data or “big data”, is time consuming, costly, and computationally complex. The data processing difficulties derive primarily from the sheer volumes of data. While the collection of data from websites, online accounts, or devices can be relatively easy, the storage, transfer, security, handling, maintenance, and processing of the data is not. Data is collected by various entities such as companies, governments, medical facilities, universities, and researchers, among many others. The amount of data collected and the rate at which the data is collected continue to expand wildly. Every time an individual uses a personal electronic device, logs onto a computer network, buys an item from an online retailer, researches a political candidate, speaks to a smart speaker, or even adjusts the thermostat at home, data is collected regarding websites visited, products viewed, transactions conducted, queries asked, and adjustments made. The collected data is accumulated, stored, and analyzed by the various parties who are interested in the data. The analysis of the data is performed for a wide range of purposes, all of which are computationally intensive. Computer architectures that were developed decades ago, and were once able to handle data processing requirements, now fail to meet what are typically extreme processing demands of big data. The processing demands of big data saturate or break traditional data processing systems. New processing architectures, algorithms, or techniques for analyzing, manipulating, or processing the data are emerging to address the computational issues.

Analysis or processing of the big data datasets requires specialized software tailored to the analysis or processing tasks. Big data analytics software is an example of the type of software that is used. A business uses analytics software to determine what products or services are of greatest interest to a person so that the business can offer or “push” similar or more expensive products and services (“upsell”) to the person. By more closely matching a product or service to the interests or desires of the person, that person is much more likely to “convert” or buy the product or service. Another example of a big data software application interesting to businesses involves digital media. While the datasets for digital media may lack the randomness of collected consumer data, the amount of digital media data is still very large. A business may own “live” digital media such as contemporaneous television, sports events, or news, entertainment content such as movies, and so on. The business is interested in selling that content to as many people as possible, and displaying the content on as many screens as possible. A content consumer may wish to view live television on their laptop computer, catch up on their favorite series on their tablet, or view a great movie on their large screen smart TV. The business needs to create and display multiple versions of their content so that the content displays properly on the particular screen of the content consumer, at the time the consumer wishes to view it.

### SUMMARY

Manufacturers of computing infrastructure such as that found in a datacenter typically design and build their products based on standards. These standards, which are generally accepted within a given industry or product category, include physical form factors such as the width of a data rack (19 inches) and the spacing such as 1 U (U=1.75 inches) between rows within the rack; network standards such as Gigabit Ethernet™, operating voltages, maximum current draw, and the like. The standards define component or module sizes, shapes, connector types, and other physical parameters that enable the manufacturers to build and sell equipment that can operate universally with equipment from other manufacturers. A result is that a consumer or purchaser of computing infrastructure components can choose to purchase all the equipment they require from one vendor or can “mix and match”. Standards enable the consumer to design the computing infrastructure to their particular requirements without overspending on features they do not require, or underspending on those that they do. The consumer can choose hard disk drive capacities and rotation speeds, numbers of network channels, memory speeds and sizes, etc. The components chosen can then be fitted into a standard rack, compute platform, or other component of infrastructure.

For all the benefits of standards, the standards can also be limiting. As technologies progress, products emerge that include smaller feature sizes, larger integrated circuits or chips, faster speeds, greater thermal dissipation and power consumption, or other features which are different from previous generations of products. These new technologies exceed the limitations of the previously imposed standards. A rack previously purchased for a compute platform may not be able to support new network speeds, dissipate more heat from a module, and so on. As appealing as it may seem to simply propose changing the standard, implementing a new standard would be extremely difficult and costly. Changing standards can cause an entire installed infrastructure to become obsolete. Instead, finding creative solutions that produce equipment that can operate within the confines of the standards—while introducing new features and improvements—enables technological advances to be incorporated into existing infrastructure at reduced cost.

A multi-connector module design can be used for performance scalability. A multi-connector module design can be based on a standard module form factor. The multi-connector design can add access to additional connectors within computing infrastructure, such as a compute platform, by expanding the module in the direction of an adjacent connector. The multi-connector module then can fit into existing infrastructure defined by the standard, and can expand functionality of the infrastructure. A multi-connector module can include processors, SSDs, NVRAMs, NICs, FPGAs, GPUs, acceleration ASICs, and other processing, storage, networking, or acceleration components to support the compute platform or other infrastructure. The components of the multi-connector module can enable expanded functionality of the compute platform, where the expanded functionality can include additional memory, network bandwidth, power availability, or thermal dissipation capability. The multi-connector module design can be based on minimal modification or removal of metal pieces within an enclosure.

Embodiments include a method for compute platform optimization comprising: obtaining a compute platform pluggable module form factor and functionality, wherein the form factor enables single socket plugging within a plurality of sockets on a compute platform, and wherein the form factor employs electrical connections in each socket; establishing a scaling form factor commensurate with one or more adjacent sockets on the compute platform, wherein the one or more adjacent sockets each provide similar functionality for modules, and wherein the one or more adjacent sockets can be used interchangeably without loss of functionality of the compute platform; and providing a single, integrated, rigid module according to the scaling form factor that plugs into the one or more adjacent sockets of the compute platform, wherein: the module provides expanded functionality over a single-plug form factor module; the expanded functionality is enabled through use of electrical connections of each socket of the one or more adjacent sockets; and the module is detected as a single device by the compute platform.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for a multi-connector module design for performance scalability.

FIG. 2 is a flow diagram for expanding and reducing functionality.

FIG. 3 shows a block diagram of interconnected nodes and elements.

FIG. 4 illustrates a peripheral element with connector.

FIG. 5 shows peripheral element form factors.

FIG. 6 illustrates peripheral element server usage.

FIG. 7A shows peripheral element failure.

FIG. 7B shows peripheral element replacement with peer-to-peer connection.

FIG. 8 shows power throttling with ports.

FIG. 9 illustrates an example stack.

FIG. 10 shows a block diagram of a Kahn Process Network (KPN).

FIG. 11 is a system diagram for performance scalability.

### DETAILED DESCRIPTION

The analysis and processing of substantial amounts of data that have been collected into business, medical, research, media, and other data collections or databases present complex and demanding computational problems. Due to the sheer volume of data, the processors, compute platforms, servers, and other computational infrastructure must be sufficiently powerful to store, retrieve, process, transfer, secure, or otherwise handle the data. In addition, as the amount data increases, a compute platform, for example, must scale gracefully. Graceful scaling means that processing, storing, network, and other functionalities can be added as the need arises. As discussed previously, computational infrastructure such as a compute platform can include hardware that has been designed to a standard. The standard can dictate a form factor for a module, functionality of the module, and so on. To enable expansion of functionality, one might conclude that adding more modules to the compute platform accomplishes the expanding of the functionality. However, merely adding more modules may not accomplish expanded functionality due to limitations of hardware that can operate within a standard module, communicate with a single connector and so on. Instead, designing a multi-connector module can increase functionality by designing the module to connect to multiple connectors. The multi-connector module can expand in one direction, such as height or width, in integrals of the original module size. The result is a single, integrated, rigid module that can fit into multiple module slots within the compute platform. The multi-connector modules can be fitted into the compute platform with minimal removal of metal pieces. The multi-connector modules can be operated by installing a modified device driver.

Techniques are disclosed for multi-connector module design for performance scalability. Multi-connector modules can be added to a compute platform to expand functionality of the compute platform. The expanded functionality can include additional memory or compute capacity, bandwidth, power availability, thermal dissipation, and the like. A compute platform pluggable module form factor and functionality is obtained. The form factor enables single socket plugging within a plurality of sockets on a compute platform, and the form factor employs electrical connections in each socket. A scaling form factor commensurate with one or more adjacent sockets on the compute platform is established. The one or more adjacent sockets can be adjacent along the shorter dimension of the form factor, or the adjacent sockets can be adjacent along the longer dimension of the form factor. The adjacent sockets each provide similar functionality for modules, and the adjacent sockets can be used interchangeably without loss of functionality of the compute platform. A single, integrated, rigid module is provided according to the scaling form factor that plugs into the one or more adjacent sockets of the compute platform. The module provides expanded functionality over a single-plug form factor module. The expanded functionality is enabled through use of electrical connections of each socket of the one or more adjacent sockets, and the module is detected as a single device by the compute platform.

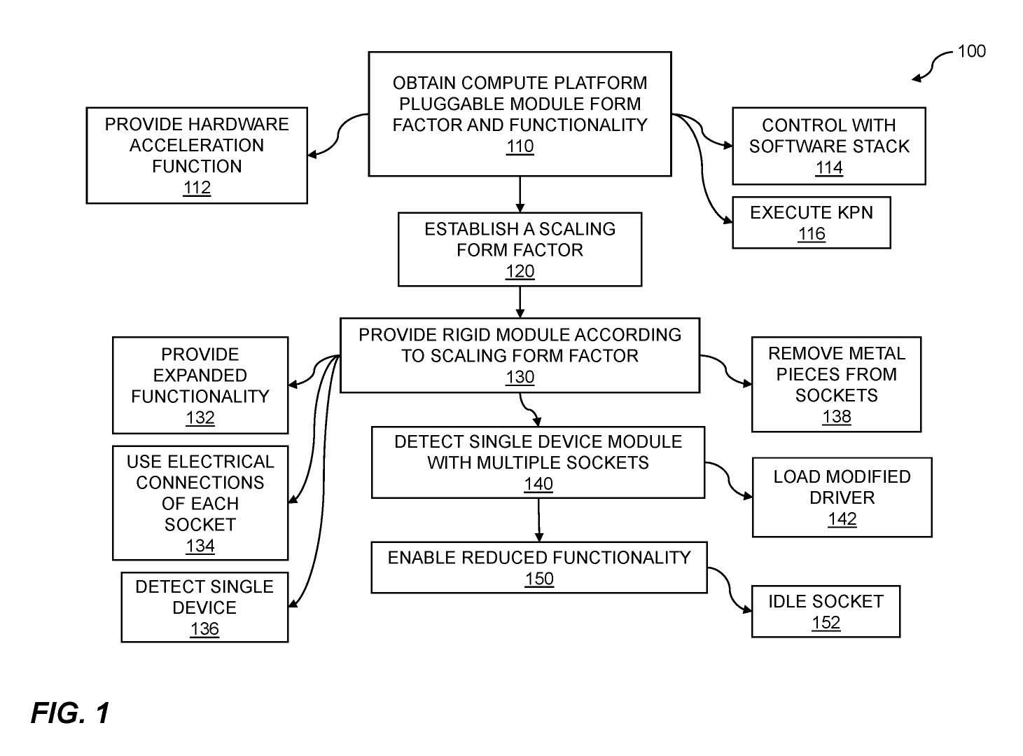

FIG. 1 is a flow diagram for a multi-connector module design for performance scalability. The multi-connector module design enables compute platform optimization using scaling. The multi-connector modules can be added to or removed from the compute platform to expand or reduce functionality of the compute platform. The adding or removing modules enables the compute platform to be scaled to meet processing needs such as the processing needs for big data, analytics, media, genomics, or other applications. The compute platform can provide a hardware acceleration function by providing processors, storage, power capacity, and so on, to support specific processing requirements. The hardware acceleration function comprises one or more domain specific frameworks. A software framework comprises software that enables a standard coding or programming technique to be used for building and deploying application software. The software framework further enables adaptation or customization of code by permitting a user to add her or his code to the framework to provide application-specific code. A framework can include enabling tools such as compilers, libraries, supporting programs, and the like. The software framework can include an application- or domain-specific framework, where the domain-specific framework can be configured to process data for a specific application or research purpose. A domain-specific framework can be applied to complex data processing applications such as machine learning or deep learning; big data analytics; media processing or transcoding; genomics sequencing; and other high data, high throughput applications. The domain-specific software framework can be executed on a hardware device set, where the hardware device set can include one or more of various types of processing elements. The domain-specific software framework can be represented by a graph such as a data flow graph or Kahn Process Network. In embodiments, the module can enable the compute platform to execute at least two of the one or more domain specific frameworks.

The flow 100 includes obtaining a compute platform pluggable module form factor and functionality 110. The pluggable module form factor can include physical dimensions of the module, where the physical dimensions can be based on standards. In embodiments, the module can include a U.2 form factor. A U.2 form factor can include physical dimensions, location of a socket, power loading data, heat dissipation capacity, and so on. A module based on the U.2 form factor can be hot-swappable. Other form factors can be used. In other embodiments, the module comprises an M.2 form factor. The form factor that is obtained can enable single socket plugging within a plurality of sockets on a compute platform. The form factor can employ electrical connections in each socket. The electrical connections can include power, data, control, and the like. In the flow 100, the compute platform can provide a hardware acceleration function 112. The hardware acceleration function can include hardware and software for computational applications such as data analysis. In embodiments, the hardware acceleration function can include one or more domain specific frameworks. The domain specific frameworks can provide software tools for specific data processing applications such as signal processing, data analytics, etc. In embodiments, the module can enable the compute platform to execute at least two of the one or more domain specific frameworks. The flow 100 further includes controlling the compute platform using a software stack 114. The software stack can generate a representation of a data processing application based on a graph such as a data flow graph, a Kahn Process Graph, and so on. The software stack can include compliers, optimizers, mappers, and other tools for processing a graph on modules, processing elements, peripheral elements, and so on. In the flow 100, the compute platform pluggable module executes a Kahn Process Network (KPN) 116. The computer platform pluggable module can execute other nets, networks, or graphs, such as Petri Nets (PN), data flow graphs (DFG), and the like.

The flow 100 includes establishing a scaling form factor 120 commensurate with one or more adjacent sockets on the compute platform. The scaling factor can be based on a physical dimension of a module, location of a socket, spacing between sockets, and so on. In embodiments, the one or more adjacent sockets can be adjacent along the shorter dimension of the form factor. The shorter dimension of the form factor can include the height of the form factor. The height of the form factor can be based on the height of a standard module. In other embodiments, the one or more adjacent sockets are adjacent along the longer dimension of the form factor. The longer dimension of the form factor can include the width of the form factor. The width of the form factor can be based on the width of a standard module. The one or more adjacent sockets can each provide similar functionality for modules. Similar functionality for modules can include pinouts, power supplied, functional equivalence except for a difference in socket identification and the like, data signals, control signals, management signals, and so on. The one or more adjacent sockets can be used interchangeably without loss of functionality of the compute platform. The selection of which adjacent socket to use has no influence on the functionality of the module within the compute platform.

The flow 100 includes providing a single, integrated, rigid module according to the scaling form factor 130 that plugs into the one or more adjacent sockets of the compute platform. As discussed throughout, the scaling form factor can be based on a standard form factor such as a U.2 form factor, an M.2 form factor, and so on. In the flow 100, the module provides expanded functionality 132 over a single-plug form factor module. The expanded functionality can include additional memory capacity, compute capacity, bandwidth, power capacity, thermal dissipation capacity, etc. In the flow 100, the expanded functionality is enabled through use of electrical connections of each socket 134 of the one or more adjacent sockets. The adjacent sockets can have identical electrical characteristics. The electrical characteristics can include power, data, control, managements, and the like. In the flow 100, the module is detected as a single device by the compute platform 136. The detection as a single device can simplify integration of the multi-connector module into the compute platform. The detection as a single device can obviate a need to modify or update a software framework, a compiler, or the like. The flow 100 includes removing one or more metal pieces from among the plurality of sockets 138 of the compute platform to enable plugging of the module. The metal pieces that can be removed can include guides, guards, rails, supports, etc. In embodiments, an enclosure of the compute platform can include metal piece modification to enable plugging of the module into the one or more adjacent sockets.

The flow 100 includes detecting a single device module that includes multiple sockets 140. The single device module can be detected based on a module identifier, a key, a code, a configuration parameter, and the like. The flow 100 can further include, upon detection of a single device module comprising multiple sockets by the compute platform, loading a modified device driver 142 for the module in the compute platform. The modified device driver can be provided by the software stack, loaded from a hardware database, and the like. The flow 100 includes enabling reduced functionality 150. Functionality can be reduced to decrease power consumption or thermal dissipation, to allow other modules to operate, to enable communication between modules, etc. The flow 100 includes enabling reduced functionality 150. The reduced functionality can be desirable to reduce power consumption or thermal dissipation; to power down, to put into a “sleep” mode peripheral elements that are unused or are awaiting data; and so on. The reduced functionality can be used to enable safe hot-swapping or one or more modules. The reduced functionality can be accomplished by idling at least one socket's set of electrical connections 152 of the one or more adjacent sockets. The idling of electrical connections can be accomplished using switches, management tools, etc.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

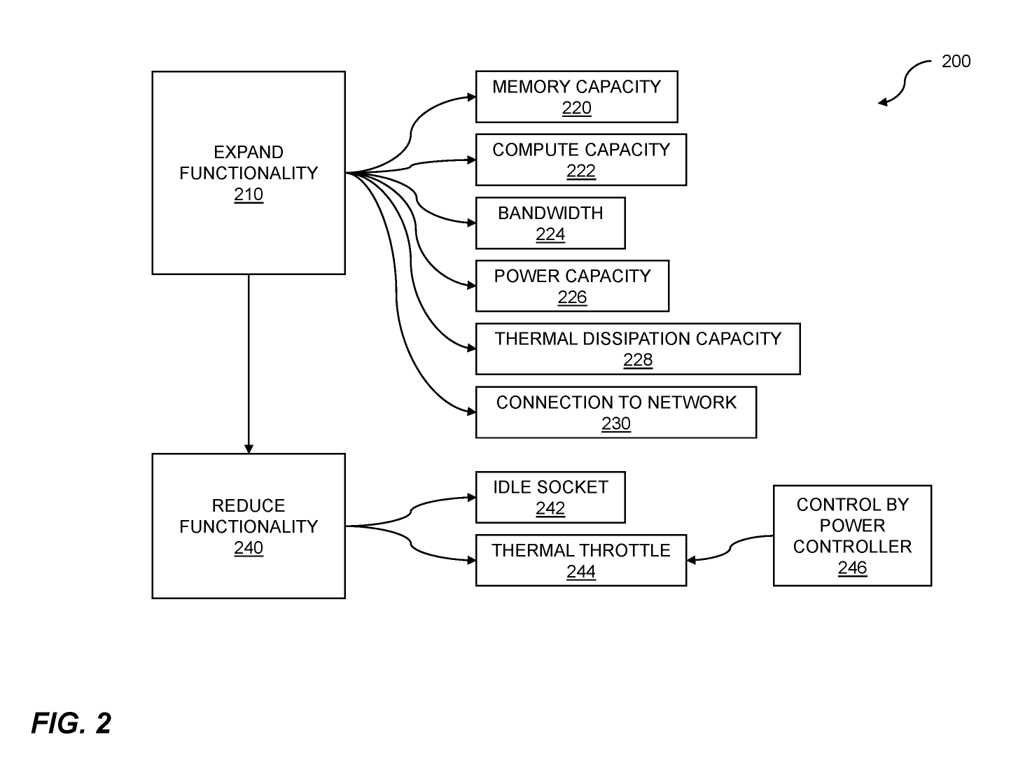

FIG. 2 is a flow diagram for expanding and reducing functionality. The functionality of computational infrastructure such as a compute platform can be expanded or reduced by adding or removing modules. Further expansion of functionality can be realized when the modules that are added can connect to multiple sockets. The multi-socket modules are based on a compute platform pluggable module form factor and functionality. The flow 200 includes expanding functionality 210. The functionality can be expanded by adding one or more multi-socket modules to the compute server. The multi-socket modules that can be added can include one or more of solid-state drives (SSDs), non-volatile random-access memories (NVRAMs), network interface cards (NICs), field programmable gate arrays (FPGAs), graphics processing units (GPUs), acceleration application specific integrated circuits (ASICs), and so on. The expanded functionality can also include connection to an interconnection network.

In the flow 200, the expanded functionality can include additional memory capacity 220. The additional memory capacity can be accomplished using synchronous DRAM (SDRAM), high bandwidth memory (HBRAM), and so on. In embodiments, the additional memory can include media or removable media such as flash memory. In the flow 200, the expanded functionality can include additional compute capacity 222. The additional compute capacity can be based on processors, central processing units, graphics processing units, FPGAs, ASICs, and the like. In the flow 200, the expanded functionality can include additional bandwidth 224. The additional bandwidth, which can include additional communication bandwidth, can include using a different communication technique, providing a faster communication connection, and so on. In the flow 200, the expanded functionality includes additional power capability 226. The additional power capability can be necessary to provide adequate power to integrated circuits within the module. The increased power capacity can be required by larger or faster integrated circuits. The additional power capacity can be accomplished by combining or “ganging” power connections of multiple connectors. In the flow 200, the expanded functionality can include additional thermal dissipation capability 228. The increased thermal dissipation capacity can be based on higher power integrated circuits within modules dissipating larger amounts of heat as the ICs operate. In the flow 200, the expanded functionality includes connection to an interconnection network 230, where the connection can be designed to enable communication among modules of the compute platform. In embodiments, the interconnection network can include peripheral component interconnect express (PCIe), remote direct memory access (RDMA), and so on. Other interconnection techniques can be used. In embodiments, the interconnection network can include a peer-to-peer (P2P) connection between one or more modules, at least one of which employs the scaling form factor.

The flow 200 includes reducing functionality 240. The reducing functionality of one or more modules within a compute platform or other component of computation infrastructure may be desirable. The reducing functionality can reduce computational costs, speed, power consumption, heat dissipation, and so on. The flow 200 further includes enabling reduced functionality by idling at least one socket's set of electrical connections 242 of the one or more adjacent sockets. Idling electrical connections can be used to selectively disable electrical components within a module. Idling electrical connections can reduce communications capacity. In the flow 200, the reduced functionality includes thermal throttling 244. Thermal throttling can be used to reduce thermal dissipation within a module, to balance thermal dissipation among modules, to balance thermal dissipation across a compute platform, and so on. In the flow 200, the thermal throttling can be controlled by a power controller unit 246. In embodiments, the control techniques can be based on a system management bus (SMB), gigabit Ethernet™ (GbE), and the like.

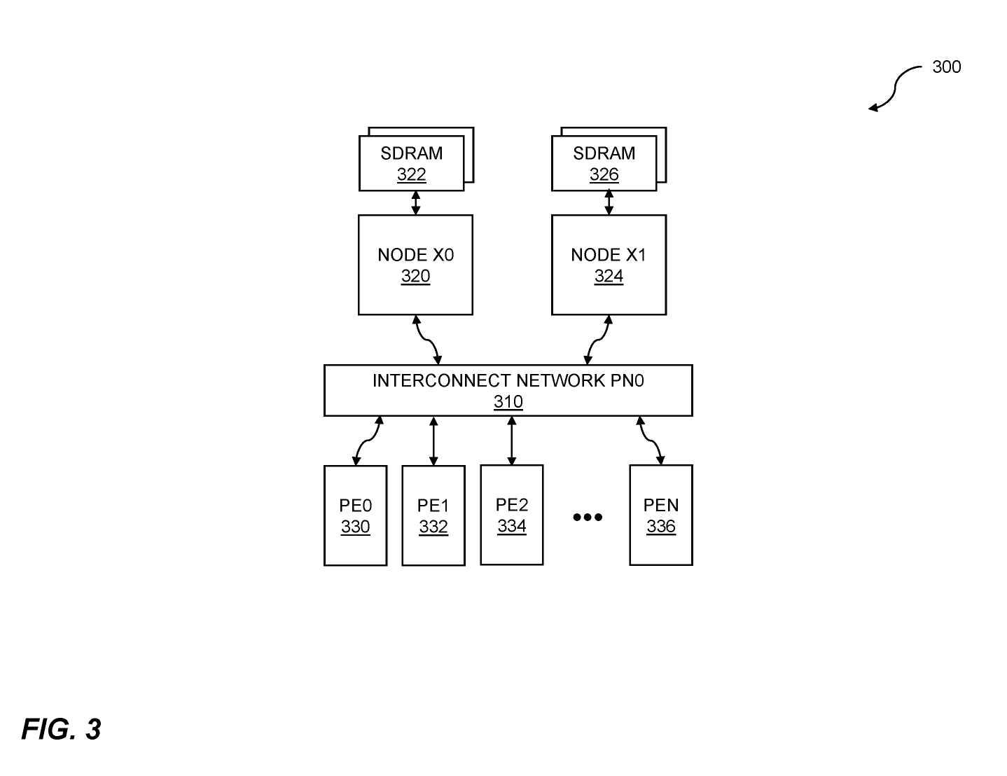

FIG. 3 shows a block diagram of interconnected nodes and elements. A compute platform 300 can comprise interconnected nodes and elements, where the nodes and elements can be provided to support platform optimization. The nodes and elements can be based on modules, where a module can include a connector. Modules can be designed with more than one connector. Multi-connector module design enables performance scalability of a compute platform.

A compute platform can include an interconnect network PN0 310. The interconnect network can include a computer network, a bus, a switch, a cross-bar switch, and so on. The interconnect network can enable communication among components of the compute platform. The compute platform can include one or more nodes such as node x0 320, node x1 324, and so on. A node such as node x0 can include a processor, a computer, a server, and the like. A node can be coupled to one or more memories. In the figure, node x0 can be coupled to SDRAM 322 and node x1 can be coupled to SDRAM 326. While SDRAM is shown, other types of memory, such as high-bandwidth (HBM) can also be used. The compute platform can include peripheral elements. The peripheral elements can include pluggable modules, where the pluggable modules are based on a module form factor and functionality. The peripheral elements can include pe0 330, pe1 332, pe2 334, pen 336, and so on. While four peripheral elements are shown, other numbers of peripheral elements can be included. The peripheral elements can expand functionality of the compute platform. The expanded functionality can include additional memory capacity, compute capacity, bandwidth, power capacity, thermal dissipation capacity, and so on. In embodiments, the expanded functionality includes one or more of SSDs, NVRAMs, NICs, FPGAs, GPUs, acceleration ASICs, and the like.

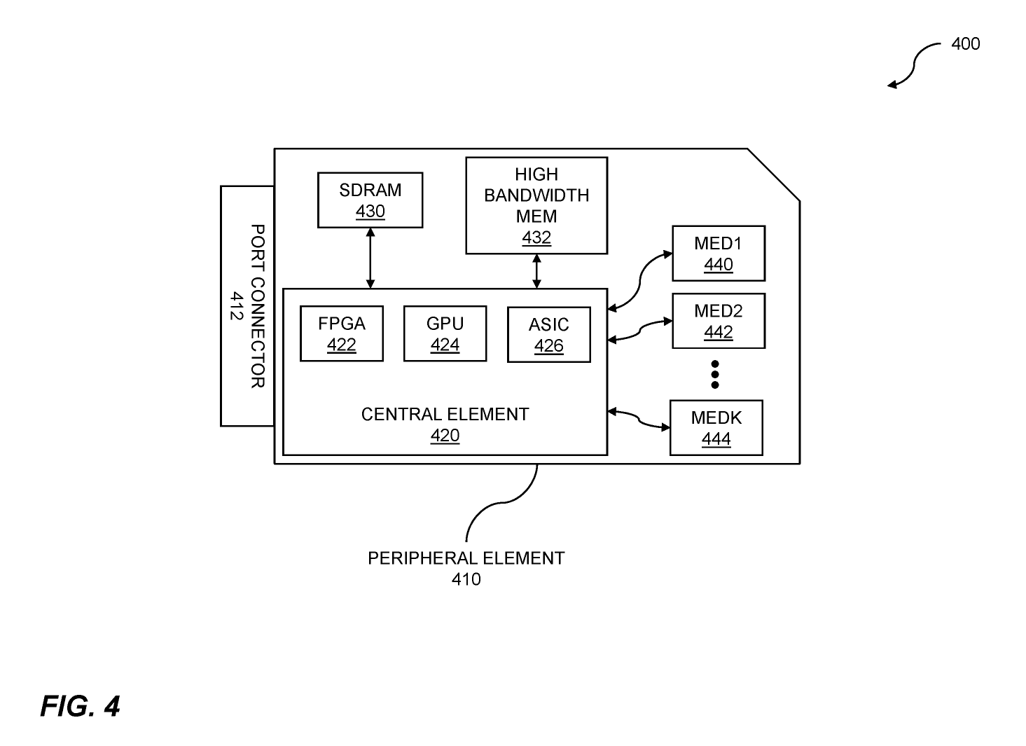

FIG. 4 illustrates a peripheral element with connector. A peripheral element 400 can include a pluggable module for a compute platform. The pluggable module can be based on a module form factor and functionality. A pluggable module can include one or more connectors. Multi-connector module design enables performance scalability of the compute platform. A multi-connector module can be designed by establishing a scaling factor commensurate with one or more adjacent sockets in the compute platform. The adjacent sockets provide similar functionality for modules, and the adjacent sockets can be used interchangeably. The multi-connector module is provided according to scaling the form factor that plugs into adjacent sockets of the compute platform. The module provides expanded functionality over a single-plug form factor module. The expanded functionality is enabled through use of electrical connections of each socket of the adjacent sockets, and the module is detected as a single device by the compute platform.

A peripheral element 410 can include a port connector 412. The port connector can connect the peripheral element to an interconnection network, where the interconnection can enable one or more communications techniques. The communications techniques can include network standards, bus standards, and so on. In embodiments, the communication techniques can include peripheral component interconnect express (PCIe), remote direct memory access (RDMA), and so on. The port connector can further enable one or more control techniques. In embodiments, the control techniques can be based on a system management bus (SMB), gigabit Ethernet™ (GbE), and the like. The peripheral element can include a central element 420. The central element can include a processor, a central processing unit (CPU), a dataflow processing unit (DPU) and so on. In embodiments, the central element can include a field programmable gate array (FPGA) 422, a graphics processing unit (GPU) 424, an application specific integrated circuit (ASIC) 426 such as an acceleration ASIC, and the like.

The central element can be coupled to one or more memories. The one or more memories can be read-only memories (ROM), read-write memories such as random access memory (RAM), and so on. The central element can be coupled to a synchronous dynamic RAM (SDRAM) 430, a high-bandwidth memory (HBM) 432, or other memory. The central element may also be coupled to one or more optional or removable media. In embodiments, the removable media can include solid-state, non-volatile memory such as flash memory. The optional media can include one or more of med1 440, med2 442, medk 444, and so on.

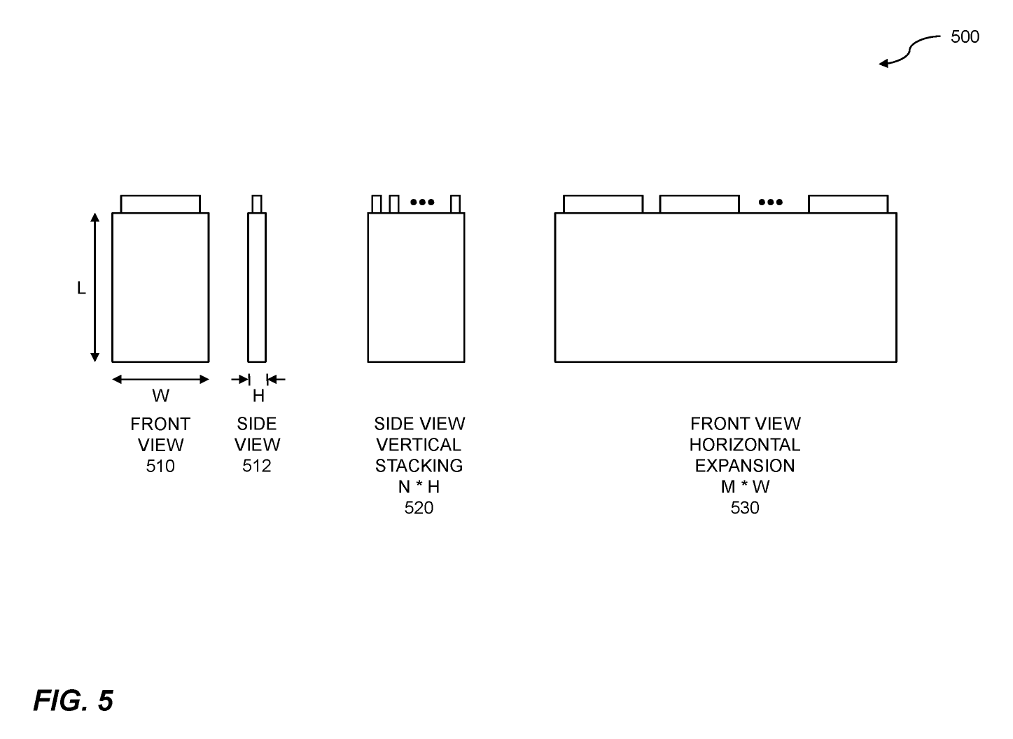

FIG. 5 shows peripheral element form factors 500. In order to expand functionality of a compute platform, single-connector modules can be replaced with multi-connector modules. The multi-connector modules can enable performance scalability by enhancing functionality of the compute platform. The expanded functionality can include additional memory capacity, compute capacity, bandwidth, power capacity, thermal dissipation capacity, and the like. In embodiments, the expanded functionality can include one or more of SSDs, NVRAMs, NICs, FPGAs, GPUs, acceleration ASICs, and so on. The element form factors are based on a compute platform pluggable module form factor and functionality. The multi-connector modules are based on scaling a single-connector form factor. A single-connector module front view is shown 510. The module has a length H and a width W. The module height H is shown in a side view 512. In order to access multiple sockets, the connectors of a multi-connector module can be located by virtually “stacking” single-connector modules. In embodiments, the one or more adjacent sockets are adjacent along the shorter dimension of the form factor. A side view of vertical stacking 520 is shown, where the height of the multi-socket module can be determined by multiplying the number of sockets N by the height of the module H or N*H. In other embodiments, the one or more adjacent sockets are adjacent along the longer dimension of the form factor. A front view of horizontal expansion 530 is shown. The width of the horizontally expanded module can be determined by multiplying the number of sockets M by the width of the module W or M*W. Thus it can be appreciated that the height of the horizontally expanded module remains H, as shown in 512, and the width of the vertically expanded module remains W, as shown in 510.

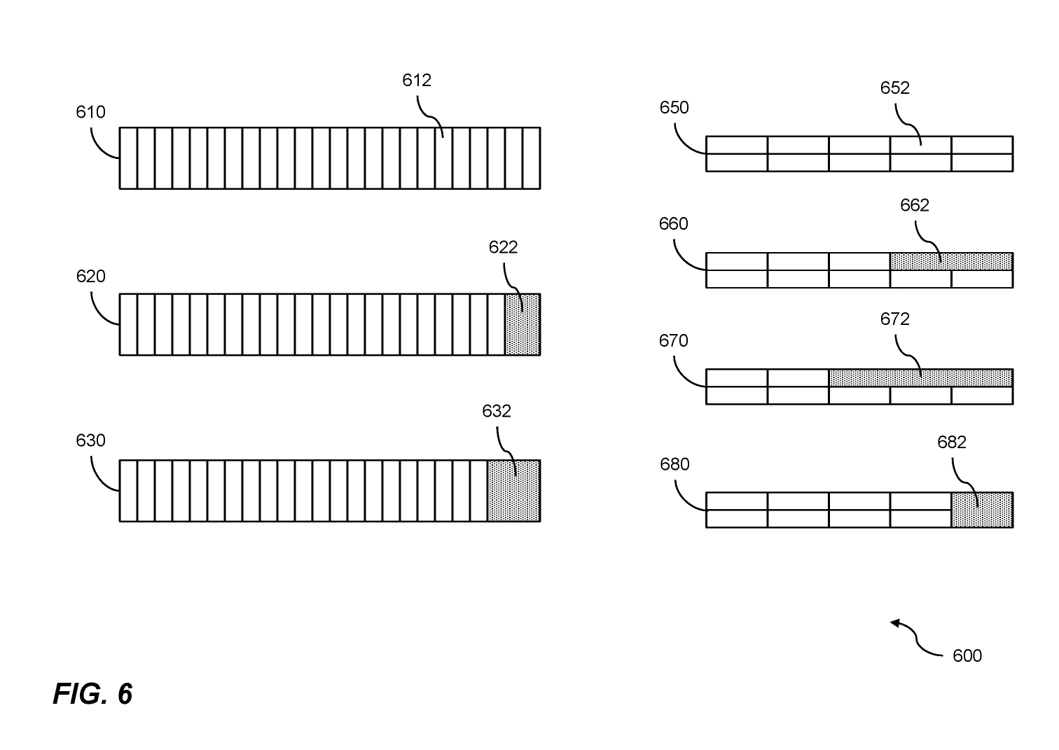

FIG. 6 illustrates peripheral element server usage. Multi-connector module design is used for performance scalability. The multi-connector modules can include various form factors to enable a module to connect to more than one socket within a compute platform. To connect to more than one socket, a multi-connector module can keep two dimensions, such as length and width, constant while varying the third dimension, height, to access adjacent sockets. In embodiments, the one or more adjacent sockets can be adjacent along the shorter dimension of the form factor. Other dimensions may be held constant or varied, such as keeping length and height constant while varying width. In further embodiments, the one or more adjacent sockets are adjacent along the longer dimension of the form factor.

Peripheral element server usage 600 is shown for a server such as a 2 U server. The server can support modules based on a form factor such as a standard form factor. In embodiments, the module includes a U.2 form factor. Other module form factors may also be supported. In further embodiments, the module comprises an M.2 form factor, and so on. A server with a 2 U form factor, where 2 U=2×1.75 inches=3.5 inches, is shown 610. The 2 U server shown can include 24 single connector modules such as module 612. Multi-connector modules can be installed in the server. A two-connector module 622 is shown installed in server 620. Other multi-connector modules can be supported such as a three-connector module 632 installed in server 630. While two- and three connector modules are shown, modules with other numbers of connectors may also be used. A 1 U server may also be used such as server 650. A single-connector module can be oriented horizontally in the server such as module 652. In this configuration, the adjacent sockets are positioned along the longer dimension of the form factor. The modules can be based on standards such as U.2. A two-connector module 662 can be installed in server 660 to access two adjacent sockets. Similarly, three-connector module 672 can be installed in server 670 to access three adjacent sockets. In other embodiments, a two-connector module orientation can include stacking the connectors. A two-connector module 682 can be installed in server 680 to access two vertically adjacent sockets. In further embodiments, accessing vertically accessible sockets and horizontally adjacent can be combined into a single module. Whether the multiple sockets of the modules are oriented vertically or horizontally, a special driver may need to be installed in order for the multi-socket module to operate properly. Further embodiments include, upon detection of a single device module comprising multiple sockets by the compute platform, loading a modified device driver for the module in the compute platform.

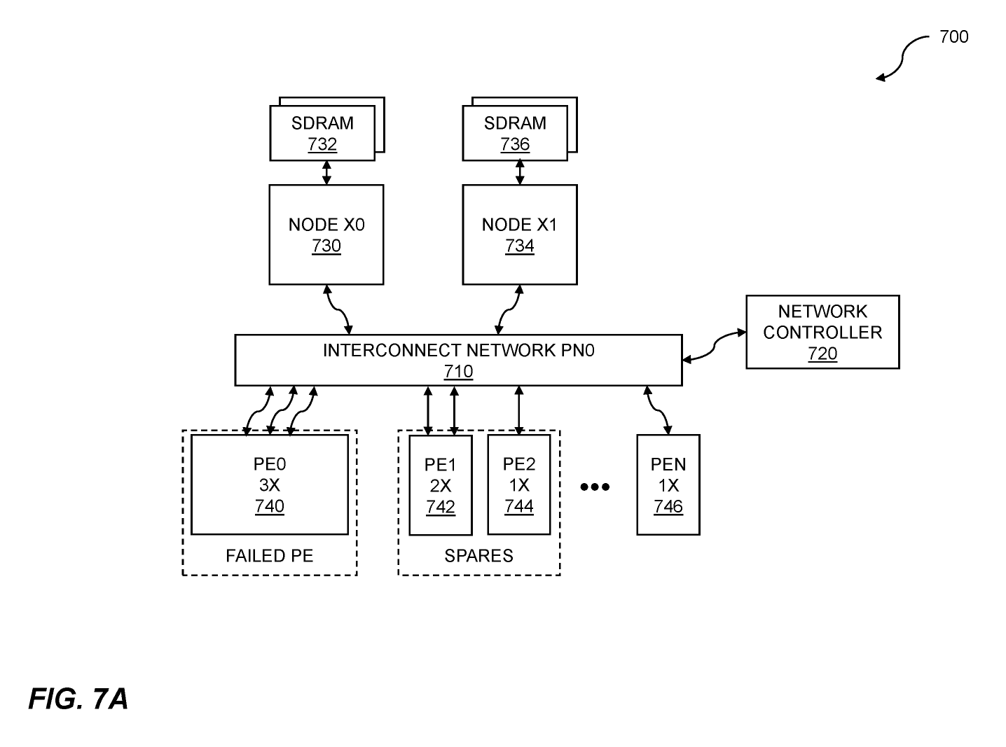

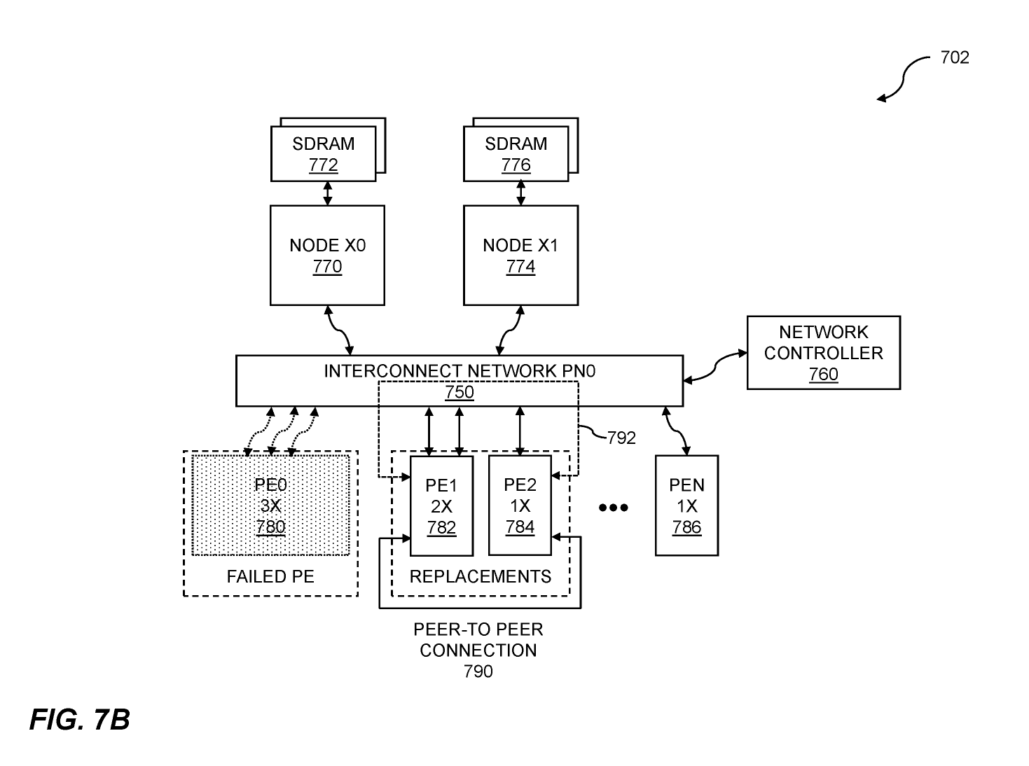

FIG. 7A shows peripheral element failure. Every component of a compute platform has a mean time to failure (MTTF). As a result, a component such as a peripheral element can fail at some point in time. The component that fails may include a multi-connector module for performance scalability. In order for the compute platform to continue to operate, unused or “spare” peripheral elements can be identified and swapped with the failed peripheral element. The swapping of the spare peripheral elements with the failed peripheral element may change the functionality of the compute platform.

An example compute platform is shown 700. The compute platform can include an interconnect network PN0 710. The interconnect network can include a computer network, a switching network such as a crossbar switch, a bus, or other network that can provide connections between and among components of the compute platform. In embodiments, the interconnection network can include a PCIe or RDMA connection. The interconnect network can be controlled by a network controller 720. The network controller can select, enable, program, or otherwise provide interconnection paths within the compute platform. The network controller can enable connections with nodes such as node X0 730, node x1 734, and so on. A node can include a processor, a dataflow processor, a graphics processor, etc. Each node can be coupled to storage, such as node x0 coupled to SDRAM 732, node x1 coupled to SDRAM 736, and so on. In embodiments, the storage can include high-bandwidth memory (HBM). The network controller can enable connections to peripheral elements such as peripheral element PE0 740, peripheral element PE1 742, peripheral element PE2 744, peripheral element PEN 746, and the like. Each peripheral element can have one or more ports such as data ports coupled to the interconnect network. PE0 has 3× data ports, PE1 has 2× data ports, PE2 has 1× data port, and PEN has 1× data port. In embodiments, a given peripheral element can have one or more data ports.

In the example, PE0 has failed. The network controller can assess the remaining peripheral elements to determine whether one or more peripheral elements are available and whether the elements can be used to replace the failed element. PE1 with two data ports, and PE2 with one data port have been identified as spares. By combining the spares PE1 and PE2, the combined spares can include the same number of data ports as the failed element PE0. The combining of the spares PE1 and PE2 can include cascading the peripheral elements, programming the elements, linking them through the interconnect network, and so on.

FIG. 7B shows peripheral element replacement with peer-to-peer connection 790. As discussed previously, a computer platform can experience a component failure, where the failed component can include a peripheral element. When unused or underutilized processing elements or “spares” can be identified, then the spare processing elements can be selected to replace the failed peripheral element. The spare peripheral elements that can be chosen to replace the failed peripheral element can be selected based on capabilities including functionality of the peripheral elements, numbers of ports, and so on. Peripheral element replacement can be used for multi-connector module design for performance scalability.

A compute platform 702 can be based on a compute platform such as 700 described previously. The compute platform can include an interconnect network PN0 750. The interconnect network can include a computer network, a switching network such as a crossbar switch, a bus, etc. The interconnect network can be controlled by a network controller 760. The network controller can provide interconnection paths within the compute platform. The network controller can enable connections with nodes such as node X0 770, node x1 774, and so on. A node can include a processing element, a dataflow processing element, etc. Each node can be coupled to storage, such as node x0 coupled to SDRAM 772, node x1 coupled to SDRAM 776, and so on. The network controller can enable connections to peripheral elements such as peripheral element PE0 780, peripheral element PE1 782, peripheral element PE2 784, peripheral element PEN 786, and the like. Each peripheral element can have one or more ports coupled to the interconnect network

In the example, the failed peripheral element PE0 can be replaced with peripheral elements PE1 and PE2. The replacement of PE0 with PE1 and PE2 can provide the equivalent number of ports between the combined peripheral elements and the interconnect network as were previously used by PE0. The combined peripheral elements PE1 and PE2 can communicate through the interconnect network or connections. In embodiments, the interconnection network can include a peer-to-peer (P2P) connection 790 between one or more modules, at least one of which employs a scaling form factor. The P2P network can be configured by the network controller and can support communications that enable the peripheral elements to be cascaded or otherwise combined. In embodiments, the P2P connection can enable inter-module communication. The inter-module communications can occur independently of the interconnect network. In other embodiments, the P2P connection can be enabled within the interconnect network PN0 792. The P2P connection within the interconnect network can be configured by the network controller then can be operated by the peripheral elements within the P2P network. In addition to sharing data, instructions, control signals, etc., the inter-module communication can enable fault tolerance. A fault that may occur in the interconnect network due to a failed peripheral element may be circumvented by communicating between modules. In further embodiments, the inter-module communication can enable swapping out a greater form factor module with two or more lesser form factor modules.

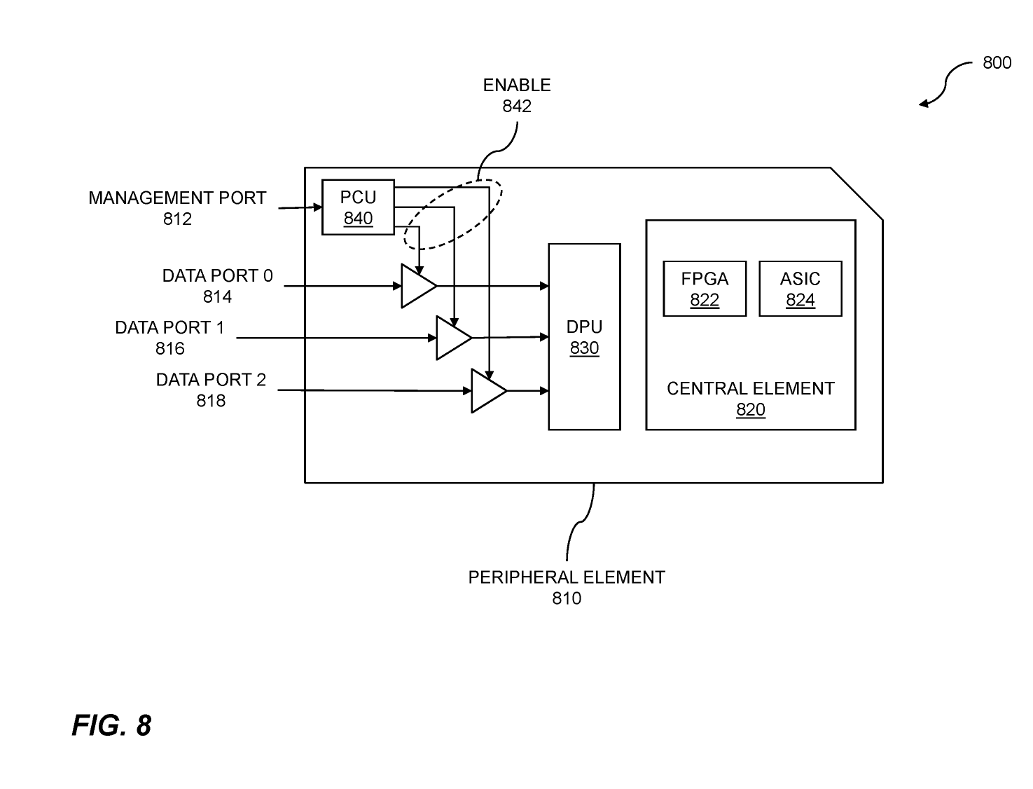

FIG. 8 shows power throttling with ports. As described throughout, a multi-connector module can be based on a design for performance scalability. One of the scalability factors can include power scalability, where power capacity of a multi-connector module can be controlled or throttled by enabling or disabling ports coupled to connectors of the multi-connector module. A compute platform pluggable module form factor and functionality are obtained that enable single socket plugging and employ electrical connections in each socket. A scaling form factor commensurate with adjacent sockets on the compute platform is established. The adjacent sockets each provide similar functionality for modules and can be used interchangeably. A single, integrated, rigid module is provided according to the scaling form factor that plugs into the adjacent sockets of the compute platform.

Power throttling 800 can be accomplished by enabling or disabling ports coupled to a peripheral element 810. The ports of the peripheral element can correspond to one or more connectors of a multi-connector module, can be incorporated within a single connector, can be partitioned across multiple connectors, and so and so on. In embodiments, a port can include one or more management ports such as management port 812, or one or more data ports such as data port 0 814, data port 1 816, data port 2 818, etc. The data ports can interface with various types of communications buses such as peripheral component interconnect express (PCIe), remote direct memory access (RDMA), etc. The management port 812 discussed previously can receive management instructions over a computer network such as the internet, where the network can support gigabit Ethernet™ or other network speed. The management port can interface with a management bus such as a system management bus (SMB).

The peripheral element can include a central element 820. The central element can include a central processing unit (CPU), a graphic processing unit (GPU), a general purpose processor, and so on. The central element can be coupled to one or more components, where the components can expand functionality. The components that can provide the expanded functionality can include one or more of solid state drives SSDs, non-volatile RAMs NVRAMs, network interface cards NICs, field programmable gate arrays FPGAs 822, graphics processing units GPUs (not shown), acceleration application specific integrated circuits ASICs 824, and the like. The peripheral element can include one or more other processing elements such as a dataflow processing unit DPU 830. The DPU can process data received from an enabled data port.

The one or more data ports coupled to the peripheral element, such as data port 0 814, data port 1 816, and data port 2 818, can be enabled or disabled to the DPU 830. The enabling or disabling of a given data port can be controlled by a power control unit (PCU) 840. The PCU can receive management instructions via the management port 812. The PCU can provide one or more enable signals 842. The enable signals can enable switches, buffers, bidirectional buffers, registers, FIFOs, and the like, that provide a data path between the data ports and the DPU. The enable signals can control the amount of power consumed by the peripheral unit by enabling or disabling the switches, buffers, etc. of the data paths. To increase data processing functionality, more data paths are enabled which contribute to higher power consumption and thermal dissipation. To decrease data processing functionality, fewer or no data paths are enabled. This reduced functionality can include thermal throttling. As discussed, by reducing power consumption, thermal dissipation can be reduced. That is, the thermal throttling can be controlled by a power controller unit. Further embodiments include enabling reduced functionality by idling at least one socket's set of electrical connections of the one or more adjacent sockets.

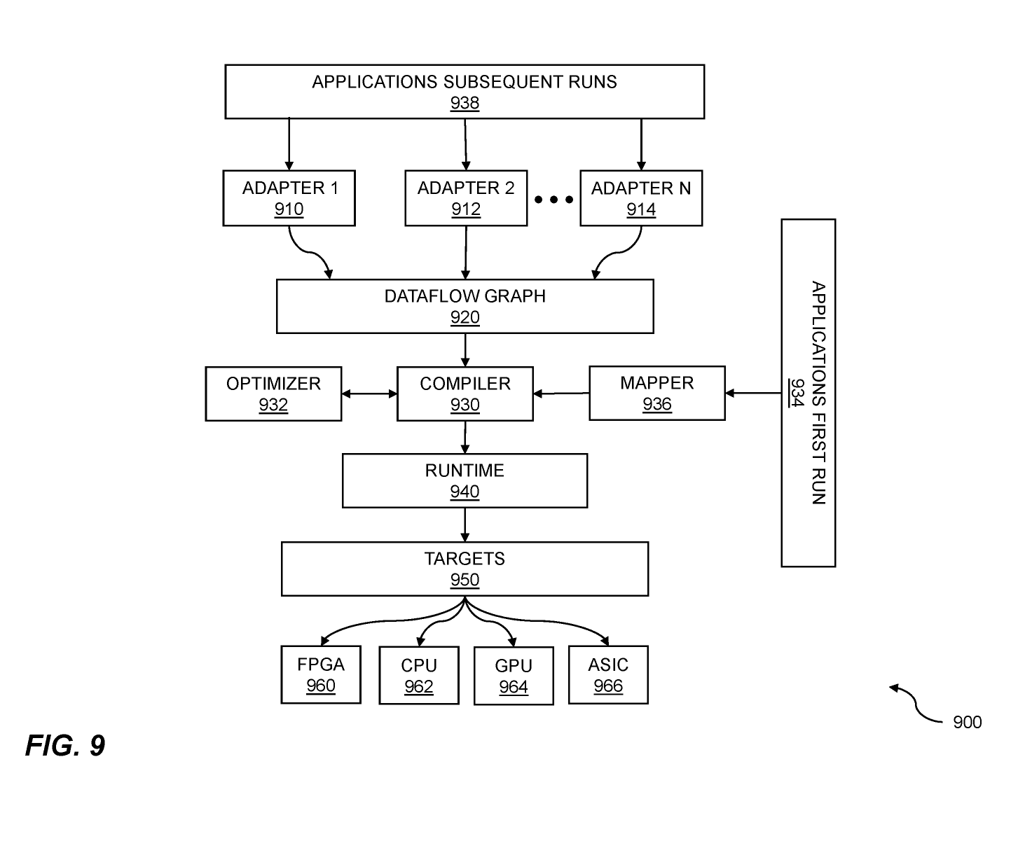

FIG. 9 shows an example stack. A stack such as an execution stack, runtime stack, or call stack, can include information related to routines, subroutines, processes, codes, and so on, pertaining to one or more programs. The one or more programs can be running or executing on one or more processors. The call stack can include a stack data structure that can support a multi-connector module design for performance scalability. A compute platform pluggable module form factor and functionality is obtained. The form factor enables single socket plugging within a plurality of sockets on a compute platform, and the form factor employs electrical connections in each socket. A scaling form factor is established, commensurate with one or more adjacent sockets on the compute platform. The one or more adjacent sockets each provide similar functionality for modules, and the one or more adjacent sockets can be used interchangeably without loss of functionality of the compute platform. A single, integrated, rigid module is provided according to the scaling form factor that plugs into the adjacent sockets of the compute platform. The module provides expanded functionality over a single-plug form factor module. The expanded functionality is enabled through use of electrical connections of each socket of the adjacent sockets, and the module is detected as a single device by the compute platform.

An example stack is shown 900. The stack can include one or more adapters such as adaptor 1 910, adapter 2 912, adapter N 914, and the like. An adapter can receive as input a software framework such as a domain-specific framework. A software framework can include a variety of basic functions such as input, output, and file handling; tool sets; compilers; libraries; and so on. A software framework can enable development of application-specific software. The functions of a software framework can be modified by developers or users to adapt the functions of a framework to specific applications. Example frameworks can include Caffe™, Caffe2™, and FFmpeg™, as well as libraries and programs for handling domain-specific data processing and analysis tasks. The data processing and analysis tasks can include machine learning or deep learning inference; big data analytics; media processing or transcoding; genomics sequencing; deep neural networks; and so on. An adapter can enable a framework to be executed on a scalable infrastructure. An adapter can couple a software framework to a data flow graph 920. A data flow graph includes nodes and arcs, where a node represents a processing task and an arc represents flow of data into, out of, between, or among one or more processing tasks. As discussed throughout, a data flow graph can be partitioned into a Kahn Process Network (KPN). The partitioning of the data flow graph into the KPN can be based on minimizing idle times of one or more processors during execution of the data flow graph. A KPN can be based on compute nodes which can be interconnected by first in first out (FIFO) buffers. The FIFO buffers can be of unlimited size. In embodiments, the compute nodes can include concurrent compute nodes. In embodiments, a scalable infrastructure can execute the Kahn Process Network.

The software stack can include a compiler 930. The data flow graph or KPN can be compiled by the compiler 930. The compiler can generate code that can be executed on an acceleration platform. The code that can be generated can describe computational, logical, or other operations to be executed. The code generated may not be directly executable on the acceleration platform. The code that can be compiled by the compiler can be optimized using an optimizer 932. The compiling can include partitioning the data flow graph or the KPN, where the partitions can be mapped to threads that can be executed on one or more processors; mapped to one or more programmable devices such as FPGAs or reconfigurable processors, and the like. In embodiments, applications 934 can be mapped to code that can be included by the compiler in compiled code. The mapping of the applications can be accomplished using a mapper 936. The applications can include functions, codes, high level computational tools, etc. The applications can include functions that can be applied to data-intensive or computation-intensive tasks such as big data analytics; deep learning or machine learning; media processing or transcoding; genomics sequencing; and so on. The applications can include convolution, pooling or max pooling; transforms such as Fast Fourier transforms (FFT); supervised or unsupervised learning techniques, and the like. The applications 934 can be mapped to code included in the compiler for the first-time processing or execution of the application code. For subsequent runs of the application code, the applications 938 can be coupled to the adapters (adapter 1 910, adapter 2 912, adapter N 914, and so on) since the application code was previously mapped and optimized.

The stack can include a runtime component 940. The runtime component can be used to ready the compiled code for execution on a variety of processors. The code can be processor independent or “agnostic”. The code can describe the various computations, logical operations, file operations, high level data operations, etc., to be performed, while remaining independent of particular operational details of the one or more processors on which the compiled code will be executed. The runtime component can perform software-defined acceleration techniques such as determining the availabilities of various processing elements. The runtime component can schedule one or more nodes of the KPN to one or more processors, can obtain data to be processed, etc. The runtime component can distribute the flow of data across one or more processors, can offload processes from oversubscribed processors and can reassign the processes to undersubscribed processors.

The stack can include a targets component 950. The targets component includes libraries, functions, applications, codes, configuration information, and so on, for executing the runtime code on one or more types of processors or hardware device sets. The targets component can analyze the runtime code to determine a hardware arrangement for a hardware device set. The hardware arrangement can include configuring a programmable device; configuring storage, processing, and communications components of a reconfigurable device; allocating computational resources on a computing device, etc. Various types of processing targets can be accommodated by the targets component. In embodiments, the processing targets, or hardware device sets, can include one or more of a field programmable gate array (FPGA) 960, a central processing unit (CPU) 962, a graphics processing unit (GPU) 964, an application-specific integrated circuit (ASIC) 966, and so on.

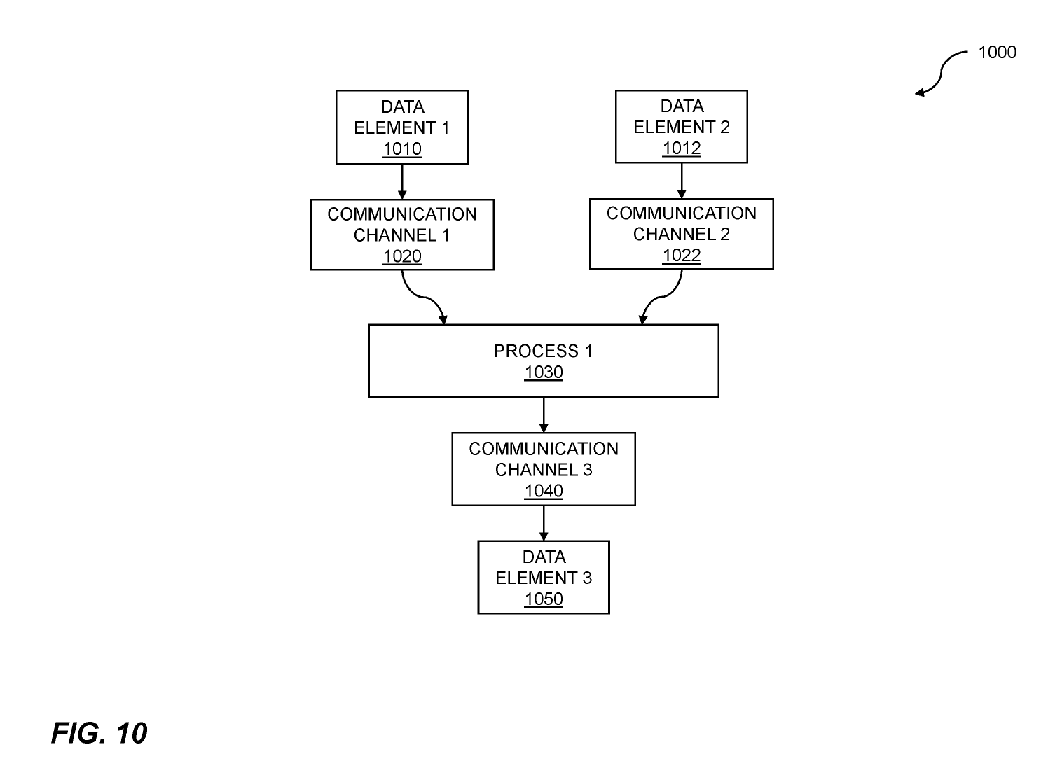

FIG. 10 illustrates a block diagram of a Kahn Process Network (KPN). A Kahn Process Network can be used to describe a distributed model for computation. The distributed model for computation can include a set of computational processes, where the processes can be deterministic. The deterministic processes communicate through channels, where the channels can be based on unbounded first in first out (FIFO) channels. A network that can be described by the KPN can include deterministic behavior, where the deterministic behavior is independent of delays that can be introduced by process computations performed by processors, or communications that take place through channels. A KPN is particularly suited to systems that process large streams of data because the KPN can operate independently of the number of processes or communications channels, the amount of data, etc. KPNs can be used to support multi-connector module design for performance scalability.

A block diagram of a Kahn Process Network including one process is shown 1000. While one process is shown, other numbers of processes may be included in a KPN. A process such as process 1 1030 can perform a variety of operations such as arithmetic operations, Boolean operations, and so on. Process 1 can perform complex operations such as signal processing operations including convolution, Fourier transforms, etc. Process 1 can receive data for processing, such as data element 1 1010 and data element 2 1012. In other embodiments, process 1 can receive other numbers of data elements such as one data element, three data elements, and so on. The data elements such as data element 1 and data element 2 are received through communication channels. In the example, process 1 receives data element 1 through communication channel 1 1020, and receives data element 2 through communication channel 2 1022. The communication channels can be used to buffer data when the rate of data input to the communication channel from a data element is different from the rate of data output from the channel to a process. The number of communications channels that provide data elements to a process depends on the number of data elements required by a given process.

When data is received by a processing element, the processing element can process the data. As discussed throughout, the process that is performed can include various operations such as arithmetic, Boolean, and other operations. The firing or execution of a process can be performed based on techniques such as a Petri Net. Execution of a process or transition occurs when data is available for processing. Using the Petri Net technique, data, called tokens, is received via communications channels to fill inputs or places of the process. The process fires or transitions when the input tokens have been received to fill all input places. The output from the process can be provided to a communication channel, to storage, to a memory, and so on. The output from the process can include a token that can fill an output place. The output of process 1 can be directed to one or more communication channels such as channel 3 1040. Communication channel 3 can be used to provide the data of data element 3 1050.

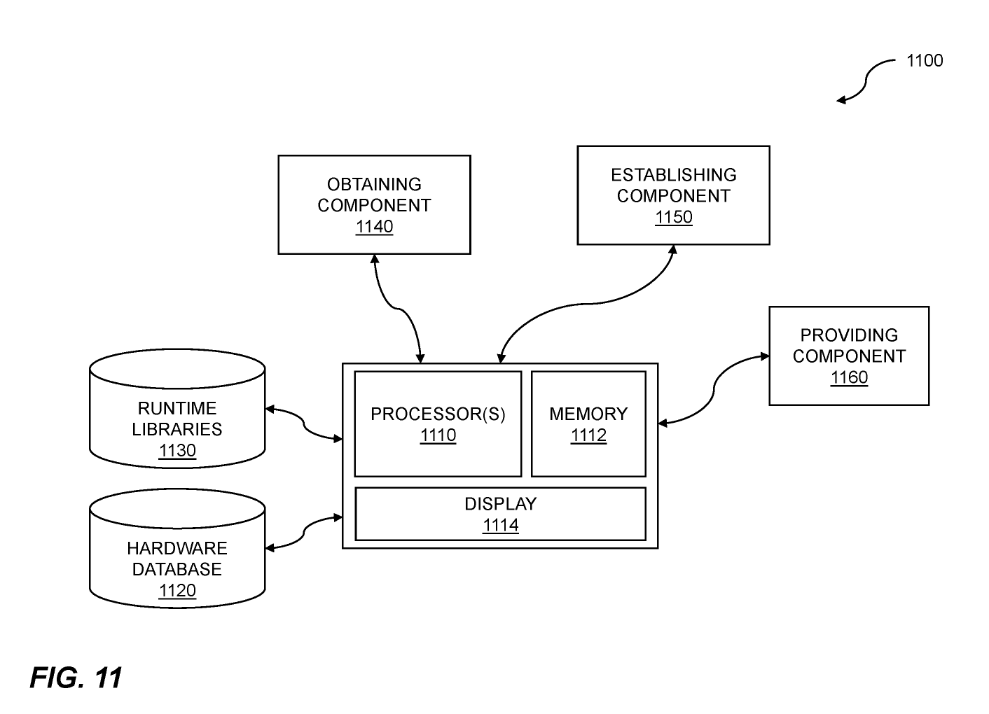

FIG. 11 is a system diagram for performance scalability. The performance scalability is based on multi-connector module design. The system 1100 can include one or more processors 1110 coupled to a memory 1112 which stores instructions. The system 1100 can include a display 1114 coupled to the one or more processors 1110 for displaying data, intermediate steps, instructions, libraries, databases, multi-connector module configurations, and so on. In embodiments, one or more processors 1110 are attached to the memory 1112 where the one or more processors, when executing the instructions which are stored, are configured to: obtain a compute platform pluggable module form factor and functionality, wherein the form factor enables single socket plugging within a plurality of sockets on a compute platform, and wherein the form factor employs electrical connections in each socket; establish a scaling form factor commensurate with one or more adjacent sockets on the compute platform, wherein the one or more adjacent sockets each provide similar functionality for modules, and wherein the one or more adjacent sockets can be used interchangeably without loss of functionality of the compute platform; and provide a single, integrated, rigid module according to the scaling form factor that plugs into the one or more adjacent sockets of the compute platform, wherein: the module provides expanded functionality over a single-plug form factor module; the expanded functionality is enabled through use of electrical connections of each socket of the one or more adjacent sockets; and the module is detected as a single device by the compute platform.

The system 1100 can include a hardware database 1120. The hardware database 1120 may be loaded into memory, storage, remote direct memory access storage, etc. The hardware data may be stored in a variety of plain text or encoded formats. The hardware database can include data relating to various types of hardware such as field programmable gate arrays (FPGA), central processing units (CPU), graphics processing units (GPU), application-specific integrated circuits (ASIC), reconfigurable processors, and so on. The hardware database can include information such as hardware arrangement descriptions relating to numbers of processors, gates, registers, communications channels, storage, etc. The hardware database can include information relating to multi-connector module design. The system 1100 can include runtime libraries 1130. The runtime libraries 1130 can include runtime instructions for a multi-connector module, a hardware device set, etc. The runtime instructions can be used to configure a multi-connector module, control the multi-connector module, communicate with the multi-connector module, and the like. In embodiments, upon detection of a single device module comprising multiple sockets by a compute platform, a modified device driver is loaded for the module in the compute platform. The runtime libraries can implement one or more routines such as low-level routines. The routines, low-level routines, and so on, can be used to perform work on a multi-connector module. A compiler can insert into compiled, executable code calls or “binary” calls to routines in the runtime libraries, enabling the work to be performed on a multi-connector module.

The system 1100 can include an obtaining component 1140. The obtaining component can include instructions, functions, or other code for obtaining a compute platform pluggable module form factor and functionality. The form factor can enable single socket plugging within a plurality of sockets on a compute platform, and the form factor can employ electrical connections in each socket. The compute platform pluggable module form factor functionality can include a description, code, operating parameters, and so on. The functionality can include a domain-specific software framework tailored for the multi-connector module, where the domain-specific software framework can include instructions, code, or functions that can support operations on the multi-connector module. Other code such as code written by or provided by a user can be used to supplement or change the operations of the software framework, to support software that can be specific to an application. The system 1100 can include an establishing component 1150. The establishing component can include instructions, functions, or other code for establishing a scaling form factor commensurate with one or more adjacent sockets on the compute platform. In embodiments, the one or more adjacent sockets are adjacent along the shorter dimension of the form factor. Such adjacent sockets can include sockets such as vertical sockets in a blade server. In other embodiments, the one or more adjacent sockets are adjacent along the longer dimension of the form factor. The adjacent sockets can include horizontal sockets within a form factor. In embodiments, the module can include a U.2 form factor. The module can be hot-swappable. In other embodiments, the module comprises an M.2 form factor. The one or more adjacent sockets can each provide similar functionality for modules, and the one or more adjacent sockets can be used interchangeably without loss of functionality of the compute platform.

The system 1100 can include a providing component 1160. The providing component can include instructions, functions, or other code for providing a single, integrated, rigid module according to the scaling form factor that plugs into the one or more adjacent sockets of the compute platform. The module that is based on the scaling form factor can provide expanded capabilities to the compute platform. In embodiments, the module provides expanded functionality over a single-plug form factor module. The expanded functionality can include additional memory, compute capacity, bandwidth, power capacity, and so on. In embodiments, the expanded functionality includes one or more of SSDs, NVRAMs, NICs, FPGAs, GPUs, and acceleration ASICs. The expanded functionality can further include connection to an interconnection network. In other embodiments, the expanded functionality is enabled through use of electrical connections of each socket of the one or more adjacent sockets, and the module is detected as a single device by the compute platform.

The system 1100 can include a computer program product embodied in a non-transitory computer readable medium for platform optimization, the computer program product comprising code which causes one or more processors to perform operations of: obtaining a compute platform pluggable module form factor and functionality, wherein the form factor enables single socket plugging within a plurality of sockets on a compute platform, and wherein the form factor employs electrical connections in each socket; establishing a scaling form factor commensurate with one or more adjacent sockets on the compute platform, wherein the one or more adjacent sockets each provide similar functionality for modules, and wherein the one or more adjacent sockets can be used interchangeably without loss of functionality of the compute platform; and providing a single, integrated, rigid module according to the scaling form factor that plugs into the one or more adjacent sockets of the compute platform, wherein: the module provides expanded functionality over a single-plug form factor module; the expanded functionality is enabled through use of electrical connections of each socket of the one or more adjacent sockets; and the module is detected as a single device by the compute platform.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A method for compute platform optimization comprising:
obtaining a compute platform pluggable module form factor and functionality, wherein the form factor enables single socket plugging within a plurality of sockets on a compute platform, and wherein the form factor employs electrical connections in each socket;
establishing a scaling form factor commensurate with one or more adjacent sockets on the compute platform, wherein the one or more adjacent sockets each provide similar functionality for modules, and wherein the one or more adjacent sockets can be used interchangeably without loss of functionality of the compute platform; and
providing a single, integrated, rigid module according to the scaling form factor that plugs into the one or more adjacent sockets of the compute platform, wherein:
the module provides expanded functionality over a single-plug form factor module;
the expanded functionality is enabled through use of electrical connections of each socket of the one or more adjacent sockets; and
the module is detected as a single device by the compute platform.

2. The method of claim 1 wherein the one or more adjacent sockets are adjacent along the shorter dimension of the form factor.

3. The method of claim 1 wherein the one or more adjacent sockets are adjacent along the longer dimension of the form factor.

4. The method of claim 1 further comprising, upon detection of a single device module comprising multiple sockets by the compute platform, loading a modified device driver for the module in the compute platform.

5. The method of claim 1 wherein the expanded functionality includes additional memory capacity.

6. The method of claim 1 wherein the expanded functionality includes additional compute capacity.

7. The method of claim 1 wherein the expanded functionality includes additional bandwidth.

8. The method of claim 1 wherein the expanded functionality includes additional power capability.

9. The method of claim 1 wherein the expanded functionality includes additional thermal dissipation capability.

10. The method of claim 1 further comprising removing one or more metal pieces from among the plurality of sockets of the compute platform to enable plugging of the module.

11. The method of claim 1 wherein an enclosure of the compute platform includes metal piece modification to enable plugging of the module into the one or more adjacent sockets.

12. The method of claim 1 wherein the expanded functionality includes one or more of SSDs, NVRAMs, NICs, FPGAs, GPUs, and acceleration ASICs.

13. The method of claim 1 wherein the expanded functionality includes connection to an interconnection network.

14. (canceled)

15. The method of claim 13 wherein the interconnection network comprises a peer-to-peer (P2P) connection between one or more modules, at least one of which employs the scaling form factor.

16. The method of claim 15 wherein the P2P connection enables inter-module communication.

17. The method of claim 16 wherein the inter-module communication enables fault tolerance.

18. The method of claim 16 wherein the inter-module communication enables swapping out a greater form factor module with two or more lesser form factor modules.

19. The method of claim 1 further comprising enabling reduced functionality by idling at least one socket's set of electrical connections of the one or more adjacent sockets.

20. The method of claim 19 wherein the reduced functionality comprises thermal throttling.

21. The method of claim 20 wherein the thermal throttling is controlled by a power controller unit.

22. The method of claim 1 wherein the compute platform provides a hardware acceleration function.

23. The method of claim 22 wherein the hardware acceleration function comprises one or more domain specific frameworks.

24. (canceled)

25. The method of claim 1 wherein the module comprises a U.2 form factor.

26. The method of claim 1 wherein the module comprises an M.2 form factor.

27-29. (canceled)

30. A computer program product embodied in a non-transitory computer readable medium for platform optimization, the computer program product comprising code which causes one or more processors to perform operations of:
obtaining a compute platform pluggable module form factor and functionality, wherein the form factor enables single socket plugging within a plurality of sockets on a compute platform, and wherein the form factor employs electrical connections in each socket;
establishing a scaling form factor commensurate with one or more adjacent sockets on the compute platform, wherein the one or more adjacent sockets each provide similar functionality for modules, and wherein the one or more adjacent sockets can be used interchangeably without loss of functionality of the compute platform; and
providing a single, integrated, rigid module according to the scaling form factor that plugs into the one or more adjacent sockets of the compute platform, wherein:
the module provides expanded functionality over a single-plug form factor module;
the expanded functionality is enabled through use of electrical connections of each socket of the one or more adjacent sockets; and
the module is detected as a single device by the compute platform.

31. A computer system for platform optimization comprising:
a memory which stores instructions;
one or more processors attached to the memory wherein the one or more processors, when executing the instructions which are stored, are configured to:
obtain a compute platform pluggable module form factor and functionality, wherein the form factor enables single socket plugging within a plurality of sockets on a compute platform, and wherein the form factor employs electrical connections in each socket;
establish a scaling form factor commensurate with one or more adjacent sockets on the compute platform, wherein the one or more adjacent sockets each provide similar functionality for modules, and wherein the one or more adjacent sockets can be used interchangeably without loss of functionality of the compute platform; and
provide a single, integrated, rigid module according to the scaling form factor that plugs into the one or more adjacent sockets of the compute platform, wherein:
the module provides expanded functionality over a single-plug form factor module;
the expanded functionality is enabled through use of electrical connections of each socket of the one or more adjacent sockets; and
the module is detected as a single device by the compute platform.
